(19) United States
(12) Patent Application Publication
(10) Pub. No.: US 2026/0331140 A1
(43) Pub. Date: Oct. 22, 2026

(54) METHOD, APPARATUS, DEVICE AND STORAGE MEDIUM FOR VIDEO GENERATION

(71) Applicants: Beijing Zitiao Network Technology Co., Ltd., Haidian District, Beijing (CN); Lemon Inc., Grand Cayman (KY)

(72) Inventors: Xin Gu, Beijing (CN); Guang Chen, Los Angeles, CA (US); Xinyao Wang, Los Angeles, CA (US); Ye Yuan, Los Angeles, CA (US); Yufei Wang, Los Angeles, CA (US); Longyin Wen, Los Angeles, CA (US); Zijian Hu, Los Angeles, CA (US)

(21) Appl. No.: 19/117,513

(22) PCT Filed: Dec. 12, 2023
(86) PCT No.: PCT/CN2023/138098

§ 371 Date: Apr. 1, 2025

(30) Foreign Application Priority Data
Jan. 6, 2023 (CN) 202310020838.6

(51) Int. Cl. G11B 27/036; G06F 40/166; G06V 20/40; G11B 27/34

(52) U.S. Cl. CPC G11B 27/036; G06F 40/166; G06V 20/44; G06V 20/49; G11B 27/34

(57) ABSTRACT

The embodiment of the disclosure provides a method, a device, an apparatus, and a storage medium for video generation. The method includes: obtaining an original video, and segmenting the original video based on video content in the original video to obtain at least two video segments; generating commentary speeches corresponding to the video segments, the commentary speeches being used to describe picture content of the video segments; generating a target video according to the video segments and the corresponding commentary speeches.

This application claims priority to Chinse Patent Application No. 202310020838.6, filed Jan. 6, 2023, and entitled “METHOD, APPARATUS, DEVICE AND STORAGE MEDIUM FOR VIDEO GENERATION”, the entirety of which is incorporated herein by reference.

### FIELD

The embodiments of the disclosure relate to the technical field of image processing, and in particular, to a method, an apparatus, a device, and a computer-readable storage medium for video generation.

### BACKGROUND

An accessible video refers to a video provided for people with vision impairments. Due to the fact that people cannot watch the image content in the video normally, in the prior art, a large amount of commentary speeches is additionally arranged in the video. So that the target video for people with vision impairments is produced. Thus, people with vision impairments can “understand” the video. The technology is also widely applied in other related scenes.

In the prior art, the production process of such a video is complex, which usually requires manual recording of commentary speeches in the video, resulting in the problems of low video generation efficiency, high production cost and the like.

### SUMMARY

The embodiments of the disclosure provide a method, an apparatus, a device, and a computer-readable storage medium for video generation, and aim to overcome the problems of low video generation efficiency, high production cost and the like.

In a first aspect, an embodiment of the disclosure provides a video generation method, including:
obtaining an original video, and segmenting the original video based on the video content in the original video to obtain at least two video segments; generating commentary speeches corresponding to the video segments, the commentary speech being used to describe picture content of the video segments; generating a target video according to the video segments and the corresponding commentary speeches.

In a second aspect, an embodiment of the disclosure provides a video generation apparatus, including:
an obtaining module configured to obtain an original video, and segment the original video based on video content in the original video to obtain at least two video segments;
a commentary module configured to generate commentary speeches corresponding to the video segments, the commentary speeches being used to describe picture content of the video segments;
a generation module configured to generate a target video according to the video segments and the corresponding commentary speeches.

According to a third aspect, an embodiment of the disclosure provides an electronic device, including:
a processor, and a memory communicatively connected to the processor,
the memory storing computer-executable instructions;
the processor executing the computer-executable instructions stored in the memory to implement the video generation method of the first aspect described above or various potential designs of the first aspect.

In a fourth aspect, an embodiment of the disclosure provides a computer-readable storage medium storing computer-executable instructions, the computer-executable instructions, when executed by a processor, implementing the video generation method of the first aspect described above or various potential designs of the first aspect.

In a fifth aspect, an embodiment of the disclosure provides a computer program product including a computer program, the computer program, when executed by a processor, implementing the video generation method of the first aspect described above or various potential designs of the first aspect.

The embodiments provides a method, an apparatus, a device, and a computer-readable storage medium for video generation. The method includes: obtaining an original video, and segmenting the original video based on video content in the original video to obtain at least two video segments; generating commentary speeches corresponding to the video segments, the commentary speeches being used to describe picture content of the video segments; generating a target video according to the video segments and the corresponding commentary speeches. After obtaining the original video, it is first divided into multiple video segments based on the video content. Then, the video segments are analyzed to generate corresponding commentary speeches, followed by the synthesis of the video segments and commentary speeches to obtain the target video. This process achieves automatic generation from the original video to the target video, ensuring the rationality and accuracy of the commentary speeches in the target video, thus improving video generation efficiency and reducing production costs.

### BRIEF DESCRIPTION OF DRAWINGS

In order to more clearly illustrate the embodiments of the disclosure or the technical solutions in the prior art, the accompanying drawings used in the description of the embodiments or the prior art will be briefly introduced below, and it will be apparent that the drawings in the following description are some embodiments of the disclosure, and those skilled in the art may also obtain other drawings according to these drawings without creative labor.

FIG. 1 is an application scenario diagram of a video generation method provided by an embodiment of the disclosure;

FIG. 2 is a schematic flowchart 1 of a video generation method provided by an embodiment of the disclosure;

FIG. 3 is a flowchart of a detailed implementation process of step S101 in the embodiment shown in FIG. 2;

FIG. 4 is a flowchart of a detailed implementation process of step S102 in the embodiment shown in FIG. 2;

FIG. 5 is a schematic diagram of generating a target video provided by an embodiment of the disclosure;

FIG. 6 is a schematic flowchart 2 of a video generation method provided by an embodiment of the disclosure;

FIG. 7 is a schematic diagram of a process of obtaining a feature similarity provided by an embodiment of the disclosure;

FIG. 8 is a flowchart of a detailed implementation process of generating a corresponding commentary text in step S205;

FIG. 9 is a block diagram of a structure of a video generation apparatus provided by an embodiment of the disclosure;

FIG. 10 is a schematic diagram of a structure of an electronic device provided by an embodiment of the disclosure;

FIG. 11 is a schematic diagram of a hardware structure of an electronic device provided by an embodiment of the disclosure.

### DETAILED DESCRIPTION

In order to make the objectives, technical solutions and advantages of the embodiments of the disclosure clearer, the technical solutions in the embodiments of the disclosure will be clearly and completely described below with reference to the accompanying drawings in the embodiments of the disclosure. All other embodiments obtained by those skilled in the art based on the embodiments of the disclosure without creative efforts shall fall within the scope of the disclosure.

It should be noted that the user information (including, but not limited to, user equipment information, user personal information, etc.) and data (including, but not limited to, data for analysis, stored data, displayed data, etc.) involved in this application are authorized by the user or are sufficiently authorized by the parties. The collection, use and processing of the related data needs to comply with relevant laws, regulations and standards of related countries and areas. Corresponding operation portal is provided for the user to select authorization or decline.

The following describes an application scenario of an embodiment of the disclosure.

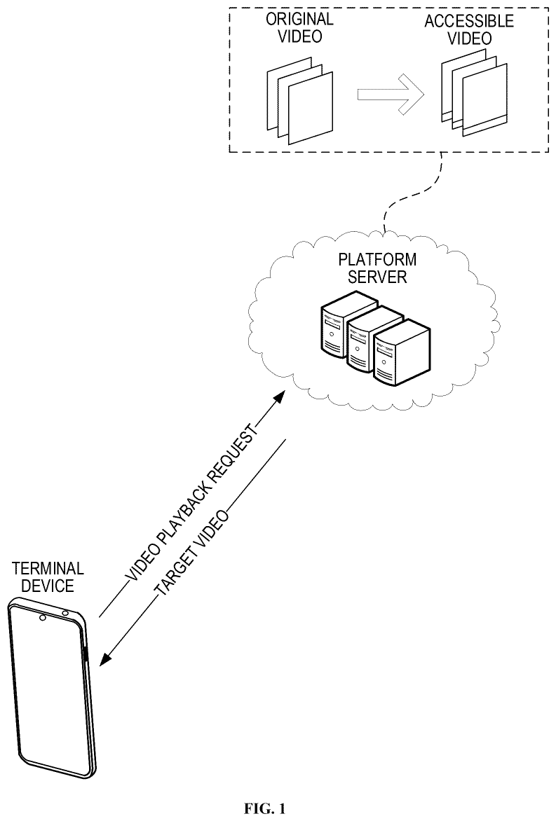

FIG. 1 is an application scenario diagram of a video generation method provided by an embodiment of the disclosure. The video generation method provided by an embodiment of the disclosure may be applied to application scenario of online generation and playback of an accessible video. Specifically, the method provided in the embodiments of the disclosure may be applied to an electronic device such as a server or a terminal device, where the server or the terminal device, after receiving the instruction, processes the regular video to generate a corresponding target video including the commentary speeches. Specifically, as shown in FIG. 1, for example, a video resource is stored in a platform server of a video platform. After receiving the video playback request sent by the terminal device to the platform server, the platform server converts the original video in the video resource to generate the accessible video, and sends the video stream of the accessible video to the terminal device, to achieve the purpose of online playback of the accessible version of the target video in the video platform on one side of the terminal device. In another possible case, the method provided in the embodiments of the disclosure may further be applied to the terminal device. That is, the terminal device performs the foregoing steps to complete a process of converting the original video into an accessible video, and details are not described herein again.

In the prior art, for example, a process of production of a video including commentary speech of such an accessible video is complex. Unlike generating corresponding subtitles based on the speech in the video, the commentary speech in the video is the result of understanding the images and pictures in the video. Meanwhile, the commentary speech needs to be played at the appropriate time in order to help visually impaired individuals clearly understand the content of the video through the descriptive audio. Therefore, in the prior art, the commentary speech in the video usually needs to be manually recorded and inserted, resulting in the problems of low video generation efficiency, high production cost and the like.

The embodiment of the disclosure provides a video generation method to solve the problem.

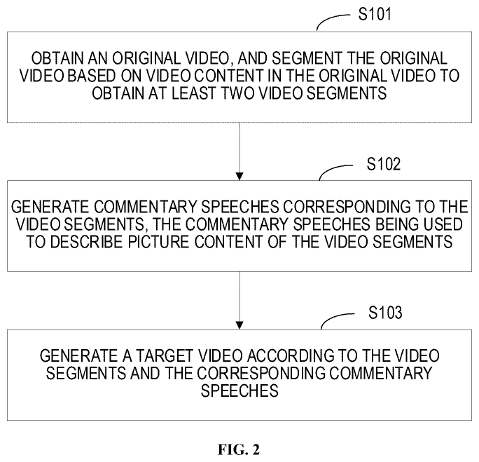

Referring to FIG. 2, FIG. 2 is a schematic flowchart 1 of a video generation method provided by an embodiment of the disclosure. The method in this embodiment may be applied to a terminal device or a server. The video generation method includes:
Step S101: obtain an original video, and segment the original video based on video content in the original video to obtain at least two video segments.

For example, the execution entity in this embodiment may be a terminal device, for example, a smart phone, or a platform server. In this embodiment, the platform server is used as an example for description. Specifically, the original video is a common video. The original video may be a video resource stored on the platform server or other storage medium. The platform server obtains the original video in response to the user instruction, and performs image recognition on the original video to obtain video information representing the video content of the original video. Then divides the original video based on the video information to obtain at least two video segments (that is, at least one segmentation).

The video information representing the video content of the original video may include, for example, at least two video content identifiers, each video content identifier corresponding to one video event and at least two video timestamps, to implement video segmentation based on a video event. For example, after image recognition is performed on the image frames in the original video to obtain video information, the video information includes a set of video content identifiers S=[#001, #002, #003], where #001, #002, and #003 are video content identifiers representing a piece of video content, respectively. The video information further includes video timestamps corresponding to #001, #002, and #003, respectively. For example, the video timestamp corresponding to #001 is [00: 00: 01-00: 01: 03]; the video timestamp corresponding to #002 is [00: 01: 04-00: 03: 14]; and the video timestamp corresponding to #003 is [00: 03: 15-00: 04: 00]. The video segment [00: 00: 01-00: 01: 03], the video segment [00: 01: 04-00: 03: 14], and the video segment [00: 03: 15-00: 04: 00] may be obtained by segmentations on the original video according to the video timestamp corresponding to the video content identifier, as described above.

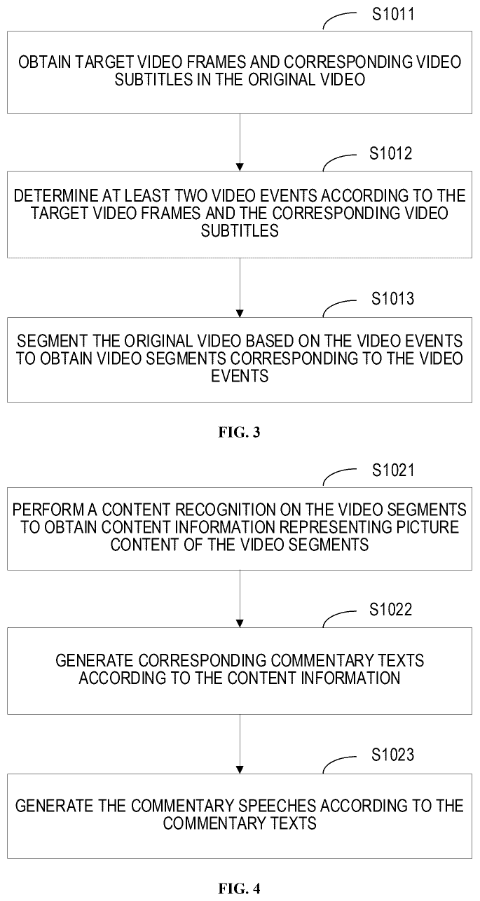

Further, as shown in FIG. 3, a detailed implementation of step S101 includes:
Step S1011: obtain target video frames and corresponding video subtitles in the original video.
Step S1012: determine at least two video events according to the target video frames and the corresponding video subtitles.
Step S1013: segment the original video based on the video events to obtain video segments corresponding to the video events.

For example, after obtaining the original video, by parsing the original video, the image video frame and the corresponding video subtitle in the original video may be obtained, where there are a plurality of manners for obtaining the video subtitle based on a specific implementation manner of the video subtitle in the original video, for example, an external or embedded subtitles. The video subtitle may be obtained by reading the subtitle file, or by performing text recognition on the subtitle region in the video frame, which is not specifically limited herein.

Furthermore, after obtaining the image video frames, the video frame with more content information among the image video frames may be determined as the target video frame, thereby better expressing the video content. For example, video frames that includes more scenes with people or objects are determined as target video frames; or, video frames with high image clarity and significant changes compared to adjacent frames (such as key frames) are determined as target video frames. Subsequently, video segmentation is performed based on the selected target video frames, so that accuracy of video segmentation may be improved, and video segments obtained by segmentation have relatively independent and complete video content, thereby improving accuracy and integrity of the content of commentary speeches generated subsequently based on video segments.

Further, there is a correspondence between the video subtitles and the target video frames, that is, the video subtitles may be used to indirectly describe the picture content in the target video frames, and there is a certain correlation between the two. Therefore, on the basis of the target video frames, the corresponding video events is determined in combination with the corresponding video subtitles. The accuracy of segmentation of the video events is improved. The segmentation of the original video is completed based on the video events. The accuracy of the picture content expressed by the obtained video segments may be further improved. In a possible implementation, according to the target video frames and the corresponding video subtitles, one dialogue scene in the original video may be determined as a video event, and then the original video is segmented based on the video event to obtain corresponding video segments.

Step S102: generate commentary speeches corresponding to the video segments, the commentary speeches being used to describe picture content of the video segments.

For example, after segmenting the original video to obtain at least two video segments, for each video segment, image recognition is performed separately to determine picture content expressed in each video frequency band. For example, the picture content expressed by the video segment #1 is “two athletes are running on the race”. The picture content expressed by video segment #2 is “The athlete is receiving an award.” Because the people with vision impairments cannot view the video picture and learn the video content, the target video needs to convert the picture content that they cannot see into voice, that is, commentary speeches, thereby realizing the expression of the picture content in the original video. In this case, there may be a plurality of manners for describing the content of the picture, for example, the environment in the scene may be described first, followed by descriptions of information on the characters and their clothing and expressions; alternatively, the clothing of characters may be described first, then their actions, and finally the environment in the picture. The specific implementation may be performed based on the content of the picture in the video segment in combination with the description rule preset by the user. In a possible implementation, the video segment may be processed based on a pre-trained natural language model, and then the sentence used to describe the picture content of the video segment, that is, the commentary speech, may be output, and details are not described herein again.

In a possible implementation, as shown in FIG. 4, a detailed implementation of step S102 includes:
Step S1021: perform a content recognition on the video segments to obtain content information representing picture content of the video segments.
Step S1022: generate corresponding commentary texts according to the content information.
Step S1023: generate the commentary speeches according to the commentary texts.

For example, the video segment contains a plurality of video frames. First, for each video frame in each video segment, image recognition is performed to obtain content information representing the image content. The content information may be a feature matrix representing image content, or may be a feature array or a feature identifier. Then, based on the natural language model, the content information is mapped into natural language, that is, commentary text. Finally, the commentary text is converted into commentary speech according to a preset voice component, which is not described in detail in the prior art.

In this process, a conversion process of “image”-“text”-“speech” is sequentially performed. The conversion from “image” to “text” is a process of semantic recognition based on image content, that is, image content of a video segment. In the semantic recognition process, a certain amount of context information needs to be used, that is, when content recognition is performed on a video segment (step S1021), multiple video frames in a video segment need to be used, and the context information provided by these frames is utilized to achieve accurate content recognition. Therefore, in order to perform the content recognition on the video segment, it is required that each video segment can provide enough context information to meet the precondition of the requirement, that is, the reasonable division of the video segment. If the video segmentation is unreasonable, it may cause that enough context information cannot be provided, thereby causing the content recognition result to be inaccurate, so that an accurate commentary speech may not be generated. In this embodiment, the original video is segmented through the video content in the original video, so that the obtained video segment is divided based on the video events (rather than the fixed time period), so that the generated video segment may provide enough upper text information in the process of generating the commentary speech, so that the generated commentary text can accurately express the picture content, thereby improving the accuracy and rationality of the generated commentary speech.

Step S103: generate a target video according to the video segments and the corresponding commentary speeches.

For example, after the commentary speech corresponding to the video segment is generated, the video segment and the corresponding commentary speech are synthesized to generate a video including the commentary speech track, that is, the accessible video (target video). FIG. 5 is a schematic diagram of generating a target video provided by an embodiment of the disclosure. As illustrated in FIG. 5, after analyzing the original video, the original video is divided into video segments Video_1, Video_2, and Video_3. Then, scene parsing is performed on the video segments Video_1, Video_2, and Video_3 to generate commentary speech Lec_1, Lec_2, and Lec_3 respectively corresponding to the video segments Video_1, Video_2, and Video_3; then, the commentary speech Lec_1 is inserted into Video_1 to obtain re_Video_1; the commentary speech Lec_2 is inserted into Video_2 to obtain re_Video_2; the commentary speech Lec_3 is inserted into Video_3 to obtain re_Video_3. Finally, re_Video_1, re Video_2, and re_Video_3 are combined in order to generate the target video.

In this embodiment, the original video is obtained, and the original video is segmented based on the video content in the original video to obtain at least two video segments; commentary speeches corresponding to the video segments are generated, and the commentary speeches are used to describe the picture content of the video segments; and the target video is generated according to the video segments and the corresponding commentary speeches. After the original video is obtained, the original video is firstly divided into a plurality of video segments according to the video content, then the video segments are parsed to generate corresponding commentary speeches, then the video segments and the commentary speeches are synthesized to obtain the target video. Automatic generation of the original video to the target video is realized. The rationality and accuracy of the commentary speech in the target video are ensured. The video generation efficiency is improved, and the production cost is reduced.

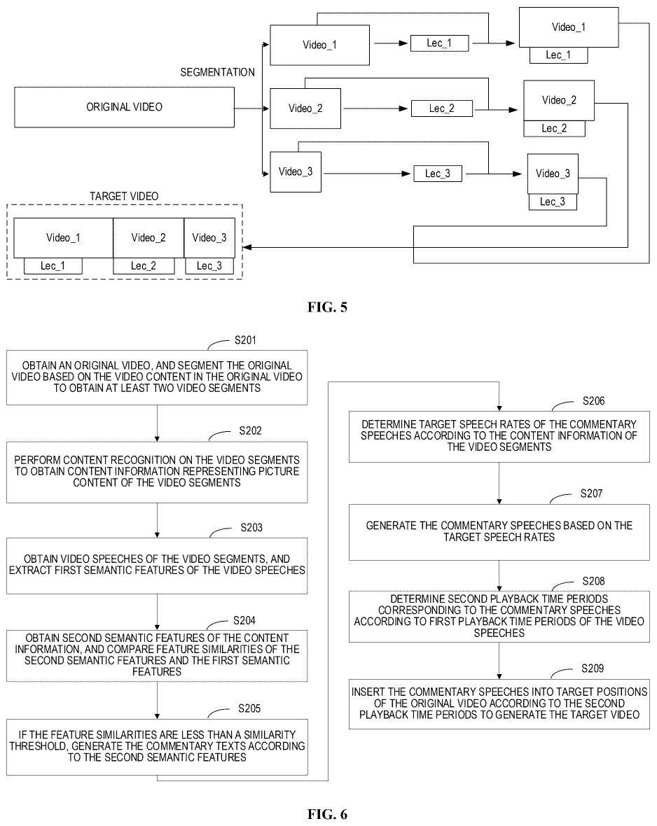

Referring to FIG. 6, FIG. 6 is a schematic flowchart 2 of a video generation method provided by an embodiment of the disclosure. In this embodiment, based on the embodiment shown in FIG. 2, step S102 is further refined, and the step of determining the playback time period of the commentary speech is added. The video generation method includes:
Step S201: obtain an original video, and segment the original video based on the video content in the original video to obtain at least two video segments.
Step S202: perform content recognition on the video segments to obtain content information representing picture content of the video segments.

For example, content recognition is performed on the video segment to obtain a feature matrix representing the visual content, i.e., the content information. Then, feature extraction is performed on the content information to obtain semantic features that describe the current visual content, referred to as the second semantic features, where the second semantic features may be low-dimensional features of the feature matrix described above, such as a feature identifier representing the type of visual content. More specifically, for example, the second semantic feature includes feature identifier #002. The content represented by feature identifier #002 is ‘two people arguing’.

Step S203: obtain video speeches of the video segments, and extract first semantic features of the video speeches.

Step S204: obtain second semantic features of the content information, and compare feature similarities of the second semantic features and the first semantic features.

Further, the video voice in the video segments is obtained, for example, the video speech is obtained by capturing the voice track data of the video segments. The video audio includes dialogues of characters in the scene, background sounds, etc. Then, semantic recognition is performed on the video speech to obtain information that represents the content feature of the video speech, that is, the first semantic features. The first semantic features have the same data dimensions as the second semantic features, enabling a feature comparison between the first and second semantic features. Specifically, for example, both the first semantic features and the second semantic feature are feature identifiers representing image content, By comparing the feature identifiers corresponding to the first and second semantic features, the feature similarity of the two can be determined. For another example, for example, both the first semantic features and the second semantic feature are feature arrays, feature matrices, or feature structures that represent image content. By comparing the feature values, feature matrices, or feature structures corresponding to the first and second semantic features, the feature similarity between the two can be determined. Further, the feature similarity may be a normalized value. The larger the feature similarity is, the more similar the two are, and vice versa; when the feature similarity is 1, it indicates that the two are the same.

FIG. 7 is a schematic diagram of a process of obtaining a feature similarity provided by an embodiment of the disclosure. The following provides a further explanation of the above process with reference to FIG. 7. As shown in FIG. 7, for a video segment A, image content recognition is performed by using a plurality of video frames in the video segment A to obtain content information corresponding to the video segment A. Then, feature extraction is performed on the content information to obtain a second semantic feature. Certainly, the foregoing step of obtaining the second semantic feature may alternatively be completed in one step, that is, feature extraction is performed on the plurality of video frames in the video segment A to obtain the second semantic feature. No specific limitation is imposed here, and it can be set as needed. This process is essentially the step of extracting image features in the video segment A. Then, the video speech of the video segment A is obtained, and feature extraction is performed on the video speech to obtain a corresponding first semantic features, the first semantic features representing content in the video speech. Therefore, the process is essentially the step of extracting the audio feature in the video segment A. Further, after the first semantic features (audio feature) and the second semantic feature (image feature) are obtained, the first semantic features (audio feature) and the second semantic feature (image feature) are compared to obtain the feature similarity. Thereafter, it is determined whether the commentary speech needs to be generated based on the feature similarity.

Step S205: if the feature similarities is less than a similarity threshold, generate the commentary texts according to the second semantic features.

For example, after the feature similarity is obtained, the necessity of generating the commentary speech is judged by using the feature similarity. Specifically, in the process of generating the commentary speech corresponding to the original video, not all segments of the original video needs “commentary”. If the video voice carried in the original video can clearly express the picture content in the video, the people with vision impairments can learn the picture content in the video through the video speech carried in the original video. In this case, the commentary speech does not need to be generated. The commentary speech needs to be generated only when the video speech in the video segment cannot express the picture content. The following describes in detail an exemplary application scenario:

For example, when the action of two characters in the video picture is “quarrel”, the video speech carried in the video segment at this time may clearly express the picture in the video that the characters in the video are quarreling. At this time, the commentary speech does not need to be generated to inform the user with visual impairments that the characters in the current picture are “quarreling”. When the action of the two characters in the video picture is “holding hands” , the video speech carried in the video segment at this time is pure music (no dialogue), and therefore the character action of “holding hands” cannot be expressed by sound. At this time, the commentary speech needs to be generated to inform the user with visual impairment that the action of the characters is “pulling” in the current picture.

Based on the above description, when the feature similarity of the first semantic features and the second semantic feature is greater than the similarity threshold, it indicates that the semantics expressed by the first semantic features and the second semantic feature are nearly the same. In this case, the video speech (the first semantic features) in the video segment can express the picture content (the second semantic feature) of the video segment. Therefore, it is unnecessary to additionally generate commentary speech to supplement the picture content of the video segment. In this case, user with vision impairments may learn the picture content in the current video according to the video speech in the video segment. While it indicates that the semantics expressed by the first semantic features and the second semantic feature have a large difference, when the feature similarity between the first semantic features and the second semantic feature is less than the similarity threshold. That is, the video speech (the first semantic features) in the video segment cannot express the picture content (the second semantic feature) of the video segment. At this time, the corresponding commentary speech needs to be generated according to the picture content of the video segment, that is, generate the commentary text according to the second semantic feature, so that the user with vision impairments can “understand” the picture content via the commentary speech.

For example, the content information includes at least first information and second information, where the first information represents a target person in the video segment. The second information represents a target action corresponding to the target person. As shown in FIG. 8, a specific implementation step of generating a corresponding commentary text in step S205 includes:
Step S2051: generate at least one group of sub-texts according to the first information and the second information, the sub-texts being used to represent target characters and corresponding target actions in the video segments at corresponding playback moments;
Step S2052: generate the commentary texts according to the sub-texts and the corresponding playback moments.

For example, the second semantic feature of the content information includes first information and second information, where the first information represents a target character in the video segment, and the second information represents target actions corresponding to the target character. According to the sending moments of the target actions corresponding to each target character, corresponding subtexts are generated. Each subtext corresponds to at least one target action of a target character. For example, the subtext A corresponds to the moment pl, and the content of the subtext A includes “the character A walking out of the gate”; the subtext B corresponds to the moment p2, and the content of the subtext B includes “the character B walking into the gate”. The specific content of subtext A and subtext B, as well as the corresponding playback moments for subtext A and subtext B, are determined based on the first and second information in the content data, where the first and second information contain the content described above. Then, the playback moment corresponding to each group of sub-text sub-cases are merged to obtain the commentary text.

Step S206: determine target speech rates of the commentary speeches according to the content information of the video segments.

Step S207: generate the commentary speeches based on the target speech rates.

For example, further, the target speech rates of the commentary speeches are the rates at which the commentary texts are converted into speech voices. After determining the content information of the video segments, the represented picture content needs to be converted into descriptive audio for playback. The commentary speeches need to be played within a certain time period to match the content of the video images, in order to avoid the issue of the commentary speeches being delayed or ahead of the video content. Therefore, before the commentary speeches are generated, the target speech rates corresponding to the commentary speeches is first determined according to the content information of the video segments.

The target speech rate may be a unit time for outputting each character in the commentary speech, and may be a specific value. For example, the target language speed=5, representing that the commentary speech outputs 5 Chinese characters per second; and the target language speed=8, representing that the commentary speech outputs 8 Chinese characters per second.

Further, the target speech rate may be determined based on the amount of information in the content information. Specifically, the amount of information is, for example, the text variable of the commentary text corresponding to the content information. The more information in the content information, the faster the target speech rate, and vice versa, the slower the target speaking rate. Therefore, the content information amount of the video segment is matched with the target speech rate. When the content displayed by the video segment is complex, more commentary texts are required for description, so that the target speech rate is relatively fast. When the content displayed by the video segment is relatively simple, less commentary text is required to be described, and therefore the target speech rate is relatively slow.

In this embodiment, the target speaking rates of the commentary speeches are determined based on the content information of the video segments, such as the variable of the commentary text corresponding to the content information. Then, commentary speeches are generated based on the target speaking rates and the commentary text. So that the playback speeds of the commentary speeches match the information amount of the content information. The problem of the commentary being speeches delayed or ahead of the video pictures is improved, and the effectiveness of the content of the commentary speeches is improved.

Step S208: determine second playback time periods corresponding to the commentary speeches according to first playback time periods of the video speeches.

Step S209: insert the commentary speeches into target positions of the original video according to the second playback time periods to generate the target video.

For example, after the commentary speech is generated, because the video segments may already include the video speeches, the generated commentary speeches and the video speeches need to be distinguished in time, thereby avoiding that the commentary speeches and the video speeches are played at the same time, causing sound overlap and affecting the listening of the users. In this embodiment, the second playback time periods that does not overlap the first playback time periods are first selected according to the first playback time periods corresponding to the video speeches in the video segments. Then, the commentary speeches are inserted into the playback positions corresponding to the second playback time periods in the video segments, that is, the target positions, to obtain the target video. Through the above steps, the commentary speeches in the obtained target video and its own video speeches do not overlap in time. The commentary speeches and the video speeches are independently played without interference. Thus the clarity of the descriptive audio playback is improved.

In this embodiment, step S201 is consistent with step S101 in the above embodiment. For detailed discussion, please refer to the discussion of step S201, and details are not described herein again.

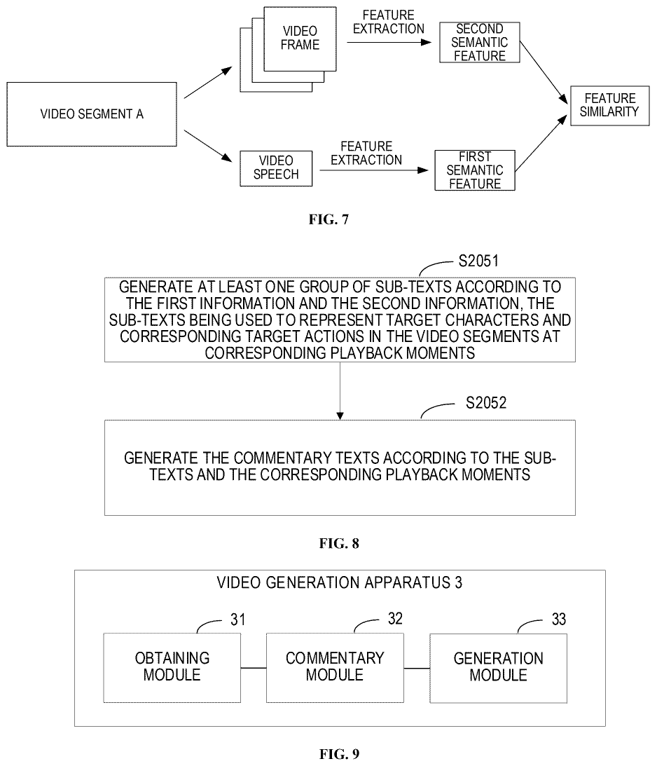

Corresponding to the video generation approaches in the embodiment described above, FIG. 9 is a structural block diagram of a video generation apparatus provided by an embodiment of the disclosure. For ease of illustration, only portions related to embodiments of the disclosure are shown. Referring to FIG. 9, the video generating apparatus 3 includes:
an obtaining module 31 configured to obtain an original video, and segment the original video based on video content in the original video to obtain at least two video segments;
a commentary module 32 configured to generate commentary speeches corresponding to the video segments, the commentary speeches being used to describe picture content of the video segments;
a generation module 33 configured to generate a target video according to the video segments and the corresponding commentary speeches.

In an embodiment of the disclosure, the commentary module 32 is specifically configured to: perform content recognition on video segments to obtain content information representing picture content of the video segments; generate corresponding commentary texts according to the content information; and generate commentary speeches according to the commentary texts.

In an embodiment of the disclosure, the commentary module 32, when generating the commentary speeches according to the commentary texts, is specifically configured to: determine target speech rates of the commentary speeches according to the content information of the video segments; and generate commentary speeches based on the target speech rates.

In an embodiment of the disclosure, the commentary module 32 is further configured to: obtain video speeches of the video segments, and extract first semantic features of the video speeches; obtain second semantic features of the content information, and compare feature similarities of the second semantic features and the first semantic features; and when generating the corresponding commentary texts according to the content information, the commentary module 32 is specifically configured to: if the feature similarity is less than the similarity threshold, generate the commentary texts according to the second semantic features.

In an embodiment of the disclosure, the content information includes at least first information and second information, where the first information represents target characters in the video segments, and the second information represents target actions corresponding to the target characters; when generating the corresponding commentary texts according to the content information, the commentary module 32 is specifically configured to: generate at least one group of subtexts according to the first information and the second information, where the subtext is used to represent target characters and corresponding target actions in the video segments at a corresponding playback moment; and generate commentary texts according to each subtext and the corresponding playback moment.

In an embodiment of the disclosure, the generating module 33 is further configured to: obtain video speeches in the video segments; determine second playback time periods corresponding to the commentary speeches according to the first play time periods of the video speeches; and when generating the target video according to the video segments and the corresponding commentary speeches, the generating module 33 is specifically configured to insert the commentary speeches into the target positions of the original video according to the second play time periods to generate the target video.

In an embodiment of the disclosure, when segmenting the original video based on the video content in the original video to obtain at least two video segments, the obtaining module 31 is specifically configured to: obtain a target video frame and a corresponding video subtitle in the original video; determine at least two video events based on the target video frame and the corresponding video subtitle; and segment the original video based on the video events to obtain a video segments corresponding to the video events.

The obtaining module 31, the commentary module 32, and the generating module 33 are connected in sequence. The video generation apparatus 3 provided in this embodiment may perform the technical solutions of the foregoing method embodiments, and implementation principles and technical effects thereof are similar, and details are not described herein again in this embodiment.

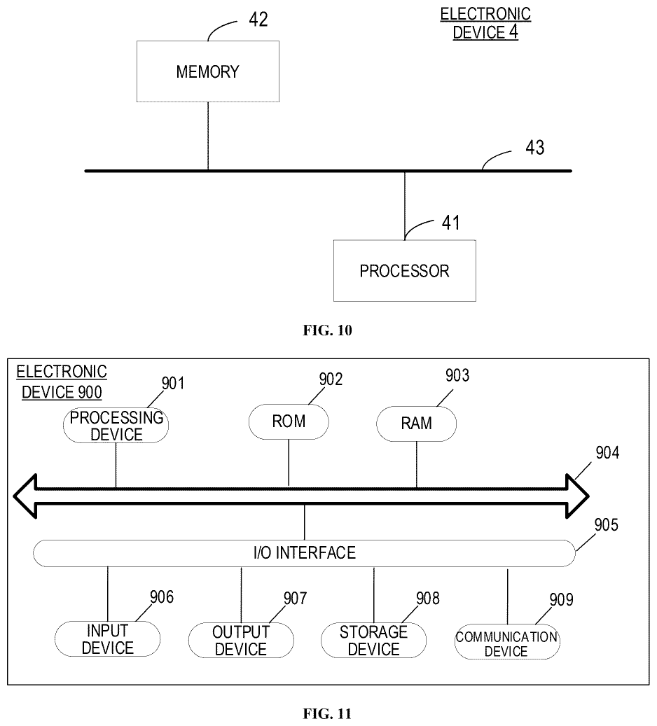

FIG. 10 is a schematic structural diagram of an electronic device according to an embodiment of the disclosure. As illustrated in FIG. 10, the electronic device 4 includes: a processor 41, and a memory 42 communicatively connected to the processor 41; the memory 42 stores computer-executable instructions; the processor 41 executes the computer-executable instruction stored in the memory 42, to implement the video generation method in the embodiments shown in FIG. 2 to FIG. 8.

Optionally, the processor 41 and the memory 42 are connected by using a bus 43.

Related descriptions may be understood with reference to related descriptions and effects corresponding to the steps in the embodiments corresponding to FIG. 2 to FIG. 8, and details are not described herein again.

An embodiment of the disclosure provides a computer readable storage medium storing computer-executable instructions, the computer-executable instructions, when executed by a processor, configured to implement the video generation method provided in any one of the embodiments corresponding to FIG. 2 to FIG. 8 of this application.

FIG. 11 shows a schematic diagram of a structure of an electronic device 900 suitable for implementing embodiments of the disclosure, and the electronic device 900 may be a terminal device or a server. The terminal device may include, but is not limited to, a mobile terminal such as a mobile phone, a notebook computer, a digital broadcast receiver, a personal digital assistant (PDA), a tablet computer (PAD), a portable multimedia player (PMP), an in-vehicle terminal (for example, an in-vehicle navigation terminal), and a fixed terminal such as a digital TV, a desktop computer, or the like. The electronic device shown in FIG. 11 is merely an example, and should not impose any limitation on the functions and scope of use of the embodiments of the disclosure.

As shown in FIG. 11, the electronic device 900 may include a processing device (for example, a central processing unit, a graphics processor, etc.) 901, which may perform various appropriate actions and processing according to a program stored in a read only memory (ROM) 902 or a program loaded into a random access memory (RAM) 903 from a storage device 908. In the RAM 903, various programs and data required by the operation of the electronic device 900 are also stored. The processing device 901, the ROM 902, and the RAM 903 are connected to each other through a bus 904. Input/output (I/O) interface 905 is also connected to bus 904.

Generally, the following devices may be connected to the I/O interface 905: an input device 906 including, for example, a touch screen, a touch pad, a keyboard, a mouse, a camera, a microphone, an accelerometer, a gyroscope, etc.; an output device 907 including, for example, a liquid crystal display (LCD), a speaker, a vibrator, etc.; a storage device 908 including, for example, a magnetic tape, a hard disk, etc.; and a communication device 909. The communication device 909 may allow the electronic device 900 to communicate wirelessly or wired with other devices to exchange data. While FIG. 11 shows an electronic device 900 having various devices, it should be understood that it is not required to implement or have all illustrated devices. More or fewer devices may alternatively be implemented or provided.

In particular, according to an embodiment of the disclosure, the process described above with reference to the flowchart may be implemented as a computer software program. For example, embodiments of the disclosure include a computer program product including a computer program embodied on a computer readable medium, the computer program including program code for performing the method shown in the flowchart. In such embodiments, the computer program may be downloaded and installed from the network through the communication device 909, or installed from the storage device 908, or from the ROM 902. When the computer program is executed by the processing apparatus 901, the functions described above and defined in the method of the embodiments of the disclosure are performed.

It should be noted that the computer-readable medium described above may be a computer readable signal medium, a computer readable storage medium, or any combination of the foregoing two. The computer-readable storage medium may be, for example, but not limited to, an electrical, magnetic, optical, electromagnetic, infrared, or semiconductor system, apparatus, or device, or any combination thereof. More specific examples of computer-readable storage media may include, but are not limited to, an electrical connection having one or more wires, a portable computer diskette, a hard disk, a random access memory (RAM), a read-only memory (ROM), an erasable programmable read-only memory (EPROM or Flash memory), an optical fiber, a portable compact disk read-only memory (CD-ROM), an optical storage device, a magnetic storage device, or any suitable combination of the above. In the disclosure, a computer-readable storage medium may be any tangible medium containing or storing a program that may be used by or in connection with an instruction execution system, apparatus, or device. In the disclosure, a computer readable signal medium may include a data signal propagated in baseband or as part of a carrier, where the computer readable program code is carried. Such propagated data signals may take a variety of forms including, but not limited to, electromagnetic signals, optical signals, or any suitable combination of the foregoing. The computer readable signal medium may also be any computer readable medium other than a computer readable storage medium that may send, propagate, or transmit a program for use by or in connection with an instruction execution system, apparatus, or device. The program code embodied on the computer-readable medium may be transmitted with any suitable medium, including, but not limited to: wires, optical cables, RF (radio frequency), and the like, or any suitable combination of the foregoing.

The computer-readable medium described above may be included in the electronic device; or may be separately present without being assembled into the electronic device.

The computer-readable medium carries one or more programs, and when the one or more programs are executed by the electronic device, the electronic device is enabled to perform the method shown in the foregoing embodiments.

Computer program code for performing the operations of the disclosure may be written in one or more programming languages, including object oriented programming languages, such as Java, Smalltalk, C ++, and conventional procedural programming languages, such as the “C” language or similar programming languages. The program code may execute entirely on a user computer, partially on a user computer, as a stand-alone software package, partially on a user computer, partially on a remote computer, or entirely on a remote computer or server. In the case of a remote computer, the remote computer may be connected to the user computer through any kind of network, including a local area network (LAN) or a wide area network (WAN), or may be connected to an external computer (for example, using an Internet service provider for Internet connection).

The flowcharts and block diagrams in the figures illustrate architecture, functionality, and operation of possible implementations of systems, methods, and computer program products according to various embodiments of the disclosure. In this regard, each block in the flowchart or block diagram may represent a module, program segment, or portion of code that includes one or more executable instructions for implementing the specified logical function. It should also be noted that in some alternative implementations, the functions noted in the blocks may also occur in a different order than that illustrated in the figures. For example, two consecutively represented blocks may actually be performed substantially in parallel, which may sometimes be performed in the reverse order, depending on the functionality involved. It is also noted that each block in the block diagrams and/or flowcharts, as well as combinations of blocks in the block diagrams and/or flowcharts, may be implemented with a dedicated hardware-based system that performs the specified functions or operations, or may be implemented in a combination of dedicated hardware and computer instructions.

The units involved in the embodiments of the disclosure may be implemented in software, or may be implemented in hardware. For example, the first obtaining unit may be further described as “obtaining at least two units of Internet Protocol addresses”.

The functions described above may be performed, at least in part, by one or more hardware logic components. For example, without limitation, exemplary types of hardware logic components that may be used include: field programmable gate arrays (FPGAs), application specific integrated circuits (ASICs), application specific standard products (ASSPs), system-on-a-chip (SOCs), complex programmable logic devices (CPLDs), and the like.

In the context of the disclosure, a machine-readable medium may be a tangible medium that may contain or store a program for use by or in connection with an instruction execution system, apparatus, or device. The machine-readable medium may be a machine-readable signal medium or a machine-readable storage medium. The machine-readable medium may include, but is not limited to, electronic, magnetic, optical, electromagnetic, infrared, or semiconductor systems, devices, or devices, or any suitable combination of the foregoing. More specific examples of machine-readable storage media may include electrical connections based on one or more lines, portable computer disks, hard disks, random access memory (RAM), read-only memory (ROM), erasable programmable read-only memory (EPROM or Flash memory), optical fibers, portable compact disc read-only memory (CD-ROM), optical storage devices, magnetic storage devices, or any suitable combination of the foregoing.

According to a first aspect, a video generation method is provided according to one or more embodiments of the disclosure, including:
obtaining an original video, and segmenting the original video based on video content in the original video to obtain at least two video segments; generating commentary speeches corresponding to the video segments, the commentary speeches being used to describe picture content of the video segments; generating a target video according to the video segments and the corresponding commentary speeches.

According to one or more embodiments of the disclosure, the generating commentary speeches corresponding to the video segments includes: performing a content recognition on the video segments to obtain content information representing picture content of the video segments; generating corresponding commentary texts according to the content information; generating the commentary speeches according to the commentary texts.

According to one or more embodiments of the disclosure, the generating the commentary speeches according to the commentary texts includes: determining target speech rates of the commentary speeches according to the content information of the video segments; and generating the commentary speeches based on the target speech rates.

According to one or more embodiments of the disclosure, the method further includes: obtaining video speeches of the video segments, and extracting first semantic features of the video speeches; obtaining second semantic features of the content information, and comparing feature similarities of the second semantic features and the first semantic features; generating corresponding commentary texts according to the content information, including: in response to the feature similarities being less than a similarity threshold, generating the commentary texts according to the second semantic features.

According to one or more embodiments of the disclosure, the content information includes at least first information and second information, where the first information represents target characters in the video segments, and the second information represents target actions corresponding to the target characters; generating corresponding commentary text according to the content information including: generating at least one group of sub-texts according to the first information and the second information, the sub-texts being used to represent target characters and corresponding target actions in the video segments at corresponding playback moments; and generating the commentary texts according to the sub-texts and the corresponding playback moments.

According to one or more embodiments of the disclosure, the method further includes: obtaining video speeches in the video segments; determining second playback time periods corresponding to the commentary speeches according to first playback time periods of the video speeches; the generating a target video according to the video segments and the corresponding commentary speeches including: inserting the commentary speeches into target positions of the original video according to the second playback time periods to generate the target video.

According to one or more embodiments of the disclosure, the segmenting the original video based on the video content in the original video to obtain at least two video segments includes: obtaining a target video frame and a corresponding video subtitle in the original video; determining at least two video events according to the target video frame and the corresponding video subtitle; segmenting the original video based on the video events to obtain video segments corresponding to the video events.

According to a second aspect, a video generation apparatus is provided according to one or more embodiments of the disclosure, including:
an obtaining module configured to obtain an original video, and segment the original video based on video content in the original video to obtain at least two video segments ;
a commentary module configured to generate commentary speeches corresponding to the video segments, the commentary speeches being used to describe picture content of the video segments ;
a generation module configured to generate a target video according to the video segments and the corresponding commentary speeches.

According to one or more embodiments of the disclosure, the commentary module is specifically configured to: perform content recognition on the video segments to obtain content information representing picture content of the video segments; generate corresponding commentary texts according to the content information; and generate the commentary speeches according to the commentary texts.

According to one or more embodiments of the disclosure, the commentary module, when generating the commentary speech according to the commentary texts, is specifically configured to: determine a target speech rates of the commentary speeches according to content information of the video segments; and generate the commentary speeches based on the target speech rates.

According to one or more embodiments of the disclosure, the commentary module is further configured to: obtain video speeches of the video segments, and extract first semantic features of the video speeches; obtain second semantic features of the content information, and compare feature similarities of the second semantic features and the first semantic features; and when generating the corresponding commentary texts according to the content information, the commentary module is specifically configured to: if the feature similarity is less than a similarity threshold, generate the commentary texts according to the second semantic features.

According to one or more embodiments of the disclosure, the content information includes at least first information and second information, where the first information represents target characters in the video segments, and the second information represents target actions corresponding to the target characters; when generating corresponding commentary texts according to the content information, the commentary module is specifically configured to: generate at least one group of subtexts according to the first information and the second information, where the subtext is used to represent target characters and corresponding target actions in the video segments at a corresponding playback moment; and generate the commentary texts according to the subtexts and the corresponding playback moments.

According to one or more embodiments of the disclosure, the generating module is further configured to: obtain video speeches in the video segments; determine second playback time periods corresponding to the commentary speeches according to the first playback time periods of the video speeches; when generating the target video according to the video segments and the corresponding commentary speeches, the generating module is specifically configured to insert the commentary speeches into the target positions of the original video according to the second playback time periods to generate the target video.

According to one or more embodiments of the disclosure, when segmenting the original video based on the video content in the original video to obtain at least two video segments, the obtaining module is specifically configured to: obtain a target video frame and a corresponding video subtitle in the original video; determine at least two video events based on the target video frame and the corresponding video subtitle; and segment the original video based on the video events to obtain video segments corresponding to the video events.

According to a third aspect, an electronic device is provided according to one or more embodiments of the disclosure, including: a processor, and a memory communicatively connected to the processor;

The memory storing computer executable instructions;

The processor executes the computer-executable instruction stored in the memory, to implement the video generation method according to the first aspect and various possible designs of the first aspect.

According to a fourth aspect, a computer-readable storage medium is provided according to one or more embodiments of the disclosure, where the computer-readable storage medium stores computer-executable instructions, and when the processor executes the computer-executable instruction, the video generation method according to the first aspect and various possible designs of the first aspect is implemented.

According to a fifth aspect, an embodiment of the disclosure provides a computer program product, including a computer program, where the computer program, when executed by a processor, implements the video generation method according to the first aspect and various possible designs of the first aspect.

The above description is merely an illustration of the preferred embodiments of the disclosure and the principles of the applied technology. It should be understood by those skilled in the art that the disclosure in the disclosure is not limited to the technical solutions of the specific combination of the above technical features, and should also cover other technical solutions formed by any combination of the above technical features or their equivalent features without departing from the above disclosed concept. For example, the above features are the technical solutions formed by mutually replacing technical features disclosed in the disclosure (but not limited to).

Further, while operations are depicted in a particular order, this should not be understood to require that these operations be performed in the particular order shown or in sequential order. In certain circumstances, multitasking and parallel processing may be advantageous. Likewise, while several specific implementation details are included in the discussion above, these should not be construed as limiting the scope of the disclosure. Certain features described in the context of separate embodiments may also be implemented in combination in a single embodiment. Conversely, the various features described in the context of a single embodiment may also be implemented in multiple embodiments either individually or in any suitable sub-combination.

Although the present subject matter has been described in language specific to structural features and/or methodological acts, it is to be understood that the subject matter defined in the appended claims is not necessarily limited to the specific features or acts described above. Rather, the specific features and acts described above are merely exemplary forms of implementing the claims.

1. A method for video generation, comprising:
obtaining an original video, and segmenting the original video based on video content in the original video to obtain at least two video segments;
generating commentary speeches corresponding to the video segments, the commentary speeches being used to describe picture content of the video segments; and
generating a target video according to the video segments and the corresponding commentary speeches.

2. The method of claim 1, wherein generating the commentary speeches corresponding to the video segments comprises:
performing a content recognition on the video segments to obtain content information representing picture content of the video segments;
generating corresponding commentary texts according to the content information; and
generating the commentary speeches according to the commentary texts.

3. The method of claim 2, wherein[[the]] generating the commentary speeches according to the commentary texts comprises:
determining target speech rates of the commentary speeches according to the content information of the video segments; and
generating the commentary speeches based on the target speech rates.

4. The method of claim 2, wherein the method further comprises:
obtaining video speeches of the video segments, and extracting first semantic features of the video speeches;
obtaining second semantic features of the content information, and determining a feature similarity of the second semantic features and the first semantic features; and
wherein generating the corresponding commentary texts according to the content information, comprises:
in response to the feature similarities being less than a similarity threshold, generating the commentary texts according to the second semantic features.

5. The method of claim 2, wherein the content information comprises at least first information and second information, wherein the first information represents target characters in the video segments, and the second information represents target actions corresponding to the target characters;
wherein generating corresponding commentary text according to the content information comprises:
generating at least one group of sub-texts according to the first information and the second information, the sub-texts being used to represent target characters and corresponding target actions in the video segments at corresponding playback moments; and
generating the commentary texts according to the sub-texts and the corresponding playback moments.

6. The method of claim 1, wherein the method further comprises:
obtaining video speeches in the video segments;
determining second playback time periods corresponding to the commentary speeches according to first playback time periods of the video speeches; and
wherein generating the target video according to the video segments and the corresponding commentary speeches comprises:
inserting the commentary speeches into target positions of the original video according to the second playback time periods to generate the target video.

7. The method of claim 1, wherein segmenting the original video based on the video content in the original video to obtain at least two video segments comprises:
obtaining a target video frame and a corresponding video subtitle in the original video;
determining at least two video events according to the target video frame and the corresponding video subtitle; and
segmenting the original video based on the video events to obtain video segments corresponding to the video events.

8. (canceled)

9. An electronic device, comprising: a processor, and a memory communicatively connected to the processor;
wherein the memory stores computer-executable instructions;
the processor executes the computer-executable instructions stored in the memory to implement acts comprising:
obtaining an original video, and segmenting the original video based on video content in the original video to obtain at least two video segments;
generating commentary speeches corresponding to the video segments, the commentary speeches being used to describe picture content of the video segments; and
generating a target video according to the video segments and the corresponding commentary speeches.

10-11. (canceled)

12. The electronic device of claim 9, wherein generating the commentary speeches corresponding to the video segments comprises:
performing a content recognition on the video segments to obtain content information representing picture content of the video segments;
generating corresponding commentary texts according to the content information; and
generating the commentary speeches according to the commentary texts.

13. The device of claim 12, wherein generating the commentary speeches according to the commentary texts comprises:
determining target speech rates of the commentary speeches according to the content information of the video segments; and
generating the commentary speeches based on the target speech rates.

14. The electronic device of claim 12, wherein the acts further comprise:
obtaining video speeches of the video segments, and extracting first semantic features of the video speeches;
obtaining second semantic features of the content information, and determining a feature similarity of the second semantic features and the first semantic features; and
wherein generating the corresponding commentary texts according to the content information, comprises:
in response to the feature similarities being less than a similarity threshold, generating the commentary texts according to the second semantic features.

15. The electronic device of claim 12, wherein the content information comprises at least first information and second information, wherein the first information represents target characters in the video segments, and the second information represents target actions corresponding to the target characters;
wherein generating corresponding commentary text according to the content information comprises:
generating at least one group of sub-texts according to the first information and the second information, the sub-texts being used to represent target characters and corresponding target actions in the video segments at corresponding playback moments; and
generating the commentary texts according to the sub-texts and the corresponding playback moments.

16. The electronic device of claim 9, wherein the acts further comprise:
obtaining video speeches in the video segments;
determining second playback time periods corresponding to the commentary speeches according to first playback time periods of the video speeches; and
wherein generating the target video according to the video segments and the corresponding commentary speeches comprises:
inserting the commentary speeches into target positions of the original video according to the second playback time periods to generate the target video.

17. The electronic device of claim 9, wherein segmenting the original video based on the video content in the original video to obtain at least two video segments comprises:
obtaining a target video frame and a corresponding video subtitle in the original video;
determining at least two video events according to the target video frame and the corresponding video subtitle; and
segmenting the original video based on the video events to obtain video segments corresponding to the video events.

18. A non-transitory computer-readable storage medium storing computer-executable instructions, the computer-executable instructions, when executed by a processor, implementing acts comprising:
obtaining an original video, and segmenting the original video based on video content in the original video to obtain at least two video segments;
generating commentary speeches corresponding to the video segments, the commentary speeches being used to describe picture content of the video segments; and
generating a target video according to the video segments and the corresponding commentary speeches.

19. The medium of claim 18, wherein generating commentary speeches corresponding to the video segments comprises:
performing a content recognition on the video segments to obtain content information representing picture content of the video segments;
generating corresponding commentary texts according to the content information; and
generating the commentary speeches according to the commentary texts.

20. The medium of claim 19, wherein generating the commentary speeches according to the commentary texts comprises:
determining target speech rates of the commentary speeches according to the content information of the video segments; and
generating the commentary speeches based on the target speech rates.

21. The medium of claim 19, wherein the acts further comprise:
obtaining video speeches of the video segments, and extracting first semantic features of the video speeches;
obtaining second semantic features of the content information, and determining a feature similarity of the second semantic features and the first semantic features; and
wherein generating the corresponding commentary texts according to the content information, comprises:
in response to the feature similarities being less than a similarity threshold, generating the commentary texts according to the second semantic features.

22. The medium of claim 19, wherein the content information comprises at least first information and second information, wherein the first information represents target characters in the video segments, and the second information represents target actions corresponding to the target characters;
wherein generating corresponding commentary text according to the content information comprises:
generating at least one group of sub-texts according to the first information and the second information, the sub-texts being used to represent target characters and corresponding target actions in the video segments at corresponding playback moments; and
generating the commentary texts according to the sub-texts and the corresponding playback moments.

23. The method of claim 18, wherein the acts further comprise:
obtaining video speeches in the video segments;
determining second playback time periods corresponding to the commentary speeches according to first playback time periods of the video speeches; and
wherein generating the target video according to the video segments and the corresponding commentary speeches comprises:
inserting the commentary speeches into target positions of the original video according to the second playback time periods to generate the target video.
